(19) United States
(12) Patent Application Publication
(10) Pub. No.: US 2014/0090210 A1
(43) Pub. Date: Apr. 3, 2014

(54) Clamping Device

(71) Applicant: Theodore Tillinghast, Cardiff, CA (US)

(72) Inventor: Theodore Tillinghast, Cardiff, CA (US)

(21) Appl. No.: 14/045,712

(22) Filed: Oct. 3, 2013

Related U.S. Application Data
(60) Provisional application No. 61/709,333, filed on Oct. 3, 2012.

(51) Int. Cl. B42F 1/08

(52) U.S. Cl. CPC B42F 1/08
USPC 24/67.9

(57) ABSTRACT

A clip is provided for a compressive restraining engagement of two sides with material such as money placed therebetween. The clip employs a serpentine configuration of a wire-like member to form a pair of diagonal crossing members communicating between two parallel sidewalls formed by distal ends of the member. A continuous parallel positioning of the contact surfaces of both sidewalls once engaged with material therebetween, enhances the biased engagement of the material. Planar sidewall sections may be engaged to the member sidewalls to enhance the contact with material therebetween and to enhance the ornamental aspects of the device.

This application claims priority to U.S. Provisional Patent Application No. 61/709,333 filed on Oct. 3, 2012, and is included herein in its entirety by this reference.

### BACKGROUND OF THE INVENTION

1. Field of the Invention

The present invention relates generally to clamping devices. More particularly the invention relates to a compressive clamping device imparting a biased substantially parallel sandwiched engagement of items placed between. This biased engagement over a large surface area better restricts the movement of engaged items such as paper, banknotes, or other thin planar materials such as cloth or plastic. The disclosed device employing the biasing imparted by a plurality of cris-crossed members, maintains a substantially parallel biasing contact of large surface areas upon opposing sides when used, for instance, as a money clip. The substantially parallel continuously biased side surfaces provide means to increase the contact area of engaged materials as well as rendering insertion of items for restraint therein, easier to achieve.

2. Prior Art

Clamping and holding devices for paper and paper currency such as paper clips and money clips are widely used. A conventional paper clip is typically formed from a length of metal wire, or planar metal or plastic material, which is bent to form opposing sides which bias inwardly in a configuration to secure stacks of paper such as paper currency. Another mode of paper securement used for maintaining a stack of paper, proximate to others in the stack, is a paper clip. Such paper clips conventionally utilize the elasticity of the metal wire forming opposing wire tongue portions. In the conventional configuration, when the tongue portions are forced apart, at least one of the loops is twisted or torqued resulting in a restoring force which causes the clip to grip the paper sandwiched between the tongues in a biased sandwiched engagement.

Conventional money and clip designs also suffer from a number of recurrent problems. First, such clips conventionally employ a solid connecting member engaged to or communicating into one side edge of two opposing planar members. Because the opposing planar members are engaged with a fixed length solid member, both planar member portions are also held in fixed positions at their common connection. Because one end of each opposing member cannot move relative to the other, such conventional clips angle the two opposing members from a widest separation at their common connection point to the connecting member, to a contact of both distal ends of both planar members at a narrowest point of separation.

As can be discerned, such conventional money clips and the like, by their limitation of a fixed engagement at one end and angled opposing positioning of planar sides, do not distribute a compressive bias to paper or currency sandwiched therebetween, in a manner which imparts pressure to the constrained money evenly across a large surface area of their coincident surfaces. Instead, due to the angled engagement toward their respective distal ends, to accommodate a thinner stack of paper or currency or paper, there is provided only a single small area of compressed or biased contact between each member with the sandwiched stack of paper or currency.

This single contact point and small area results in a smaller pressure point of the surface of opposing sides against constrained paper or currency at a small contact area. This is quite unlike the disclosed device herein, which communicates a biasing force of the contact surfaces of both side members evenly across a large area. Because of the small area of biased engagement on conventional clips, when the two planar members are separated at an increasing distance from each other, the amount of pressure at this single small contact area therebetween, significantly increases the difficulty of adding and removing currency or stacked paper items between the members. Insertion therebetween can be particularly difficult to achieve.

Conventional paper clip devices also fail in many aspects of their intended task of constraining stacked paper adjacently using sidewall surfaces. First, the paper clip is not easily employed on large stacks of paper or other medium due to the required increase in the angle of the sides to each other to a point where such clips are easily susceptible to permanent deformation by a bending of the metal forming them. Conventional paper clips can seldom secure stacks of paper much thicker than the width of the loops forming the clip and as such are extremely limited. Because of the extreme, non parallel angle, both side members of the clip must assume for larger stacks of paper, attempts to secure such a clip to a stack of paper thicker than a few pages, most often results in permanent deformation of the metal forming the clip thereby rendering it inoperable since its biasing force for a sandwiched engagement for subsequent thinner stacks of material will no longer be present.

In addition, for large and even moderate or small sized stacks of paper, the distal ends of the formed members or tongue portions of a wire paper clip will tend to protrude from the plane of the paper. In other words, so engaged, the clip will not lie flat and will assume a twisted engagement and therefore result in a misshapen stack of paper.

Such misconfiguration can be of quite a nuisance since it will often result in stacks of paper which are not securely engaged together. Further, the misshapen stack may not easily store in conventional folders, binders, or envelopes. Still further, the relatively sharp distal ends of the wire forming the opposing members of the clip, may tend to dig or tear into the paper. As such, removal of the clip may cause undesirable damage to the paper documents.

As a result, prior art has shown many attempts to provide improvements in the art of paperclips. A ‘butterfly clip’ is a well known alternative clip which is formed from metal wire having a central spine or crossbar portion with two overlapping legs portions typically formed into triangles engaged to and extending from the ends of the spine. The spine portion acts as a type of torsion bar, such that when the legs are forced apart as needed for the insertion of paper, the spine is twisted or torqued. In the as used position, the spine crosses over the edge of the paper stack and the leg portions are positioned on the opposite faces of the paper stack. The resultant restoring force of the torqued spine creates a torqued engagement of the ends of the spine which is then communicated to the legs to provide the compressive engagement of paper documents positioned therebetween. However, due to the configuration of a single crossing spine, the structure of the clip is in general torsionally unstable and flimsy. Further, the butterfly clip does not substantially prevent the paper from twisting and binding in its engagement with the clip when the stack of papers is jostled or simply moved from one place to another. Still further, the employment of only a single spine limits the amount of holding force the clip is able to achieve.

U.S. Pat. No. 4,949,435 to Michelson teaches a paper clip device having a spine portion, two straight side leg portions extending substantially perpendicular to each end of the top spine portion and bent portions extending from the straight side legs. This device is similar to the well known butterfly clip in that a single spine portion is employed as a type of torsion bar to communicate the restoring force of the torqued spine to the legs when engaged to a thickness of papers. In the as used mode the single spine portion similarly crosses the edge of the medium and the legs are positioned on the opposite faces. However, this device similarly falls short in that it's structure is torsionally unstable and flimsy can additionally fails to prevent the paper from twisting or binding in its engagement with the clip.

Other devices shown in prior art which similarly employ this single torsion bar/spine configuration include U.S. Pat. Nos. 2,061,474; 1,989,953; 1,783,099; and 776,974. These and similar devices fail in providing adequate securement for relatively large thicknesses or stacks of paper or other medium. A first downfall as noted above is the employment of the single spine portion with thicker materials. In the as-used mode engaged over a stack of paper or other medium, the restoring force of the torqued spine is communicated to the legs extending from the ends of the spine thereby providing a biasing force for a gripping engagement of the clip to the medium, from the twisting or torqued metal. Again, however, this structural configuration is torsionally unstable and flimsy and fails to prevent the medium it is holding from binding or twisting within the clip, and may further cause the distal ends of the legs to protrude from the plane of the paper such that the legs do not lie flat in a plane with the paper. One skilled in the art can easily discern such additional downfalls of current wire-formed paper clip devices.

Binder clips, also referred to as bulldog clips, are another known type clamping device employed for securing stacks of paper and other medium. A binder clip conventionally consists of a strip of spring steel bent into the shape of a triangle. Tension along the base of the formed triangle forces the two sides closed. A handle is engaged at the apex of the triangle on both sides and extends past the base as a type of lever which can be squeezed to open the clip for the insertion of paper between formed sidewalls. This device is generally known to provide greater holding forces compared to paper clips which are formed from portions of thin wire. However, the width of medium the binder clip can hold is limited by the thickness of the base. As such, for employment with larger stacks of paper, the binder clip is required to be formed bigger, therefore resulting in extremely bulky clips.

Money clips are another known device in prior art which are employed to securely engage and constrain paper currency and related materials. Money clips often take the form of a bulldog clip, having a fixed profile wherein two side portions are tensioned together via a common curved member base. In this conventional configuration, the thickness of the space between the walls of the base is fixed and separated. This result is in a limit to the thickness which may be inserted therebetween, and therefore amount of paper the clip can accommodate in a biased sandwiched engagement.

Since money clips are often kept in a users pocket, the need for a sleek and low profile clip are generally desired by the user. As a result, manufacturers tend to manufacture money clips in sizes which are relatively small in the spacing of the opposing side members at their common connection. However, limiting the fixed distance of the opposing members at their connection point, will limit the amount of paper currency or other medium which may be inserted and which the clip can securely hold. Typical money clip users are therefore often dissuaded from low profile designs due to this shortcoming. Alternatively, if the money clip is made larger to hold more currency, the result is a bulky and cumbersome clip, which is again undesirable.

In some designs, handles or levers are employed to allow the user to splay the clip open so it can be slid onto the material it will be holding. If these levers are fixed they create a large profile similar to a clothes-pin. To overcome this large profile some designs have levers that slide out when they are to be used and some allow the levers to pivot out when being used. Both of these designs are cumbersome, more complex and costly. Some flat spring designs also use tapered lead-in lips that allow the flat spring to splay open when it is pushed against the medium. The lead-in lips must be larger than the thickness of the material it is to be pushed onto. This again creates a large profile.

As such, there is a continuing unmet need, for an improved paper securing clip or money clip device and system of components which will allow for insertion of a single bill or large stacks of bills or papers, and still apply an evenly distributed compressive biased engagement between opposing complimentary planar members. Such a device should apply biasing pressure against constrained paper or bills, to both very short stacks, as well as thick stacks, substantially evenly. Such an even pressure in the case of a money clip and other clip devices will allow the constraint in a biased sandwiched engagement, of flatly formed items, whether they be very thin, or reaching the maximum thickness for the gap between the members. So constrained, because of the large area of biased pressure, the items are rendered more securely fastened, yet, easier to remove and to insert during use. In all cases, a planar and substantially parallel positioning of opposing sidewalls or members is maintained which is a trait which is especially preferred when the device is located in a pocket or purse to minimize occupied space.

The forgoing examples of related art and limitation related therewith are intended to be illustrative and not exclusive, and they do not imply any limitations on the invention described and claimed herein. Various limitations of the related art will become apparent to those skilled in the art upon a reading and understanding of the specification below and the accompanying drawings.

### SUMMARY OF THE INVENTION

The device herein disclosed and described provides a solution to the shortcomings in prior art in paper and currency securement devices and achieves the above noted goals through the provision of a compressive device formed from one or a plurality of bent wire-like members which form or reinforce and bias opposing side surfaces toward each other. The wire or other wire-like member forming the device may be of conventional materials such as metal wire or spring steel, however the wire-like member can be formed of any material suitable for the purposes set forth in this disclosure, and which will impart a biased sandwiched engagement to paper or material positioned between formed or engaged sidewall members of the device. Polymeric materials or carbon fiber materials may also be employed for example for the formation of the serpentine shaped wire-like members of the device.

In modes of the device employed as a money clip or paper clip, the device may employ a conventional paper clip gauge wire or wire-like member, configured or bent to form portions of the wire-like member into the opposing sides yielding the biased sandwiched engagement. Alternatively, these distal ends of each wire-like member, may also be formed and configured to engage within planar wall members which form opposing side walls of the clip device. These planar sidewalls may be formed of material suitable to the purpose such as metal or polymeric material or hybrid materials such as carbon fiber using carbon fiber or glass fiber and resin materials.

The device so formed, yields a novel component which allows for easy clipping or clamping of most thin planar mediums including paper, money, wood, plastic or just about any material which requires a quick and easily biased sandwiched engagement between an opposing pair of planar portions or segments. The pair of planar segments, communicate at respective edges with cross-positioned spring-like members running in a plane substantially normal to that of the planar segments. This flexible cross-over spring-like intersection of the wire-like member, providing the connection between the two planar members, is configured in a manner which when positioned to fully collapsed mode, with the engaged planar segments adjacent or barely separated, the opposing sections of the wire-like member impart a biased force and continue to communicate a compressive force to the opposing contact areas of the planar segments which are coincident.

Employing this novel cross-over connection, using wire-formed sidewalls or with wire-like segments in an operative engagement with the two planar components forming sidewalls, the compressive bias is communicated to substantially the entire contact surfaces of the planar segments and is also imparted to substantially the entire area of items placed in communication with the contact surfaces of these planar segments.

Unlike conventional money and paper clips which employ angled opposing planar segments when in a collapsed mode, and which only achieve a parallel configuration of the contact surfaces and sidewalls when constraining material therebetween at a maximum separation distance, the device herein maintains the contact surfaces substantially parallel, from a narrowest separation where the contact surfaces are in communication, throughout sequential positions of the contact surfaces to a widest separation distance between the contact surfaces. Because of this continuous substantially parallel positioning of the two opposing contact surfaces, the biased contact therewith with any paper or currency placed therebetween in a biased sandwiched engagement, is communicated by a contact of substantially the entire surface area of both opposing contact surfaces of each respective planar component. This wide surface contact area is unlike conventional clips which impart a high compressive force between only distal surface areas of the planar opposing components in a small area of the total area.

Further, the device herein, communicates the biasing force of the sandwiched engagement evenly against the entire surface of paper or currency positioned in a contact therebetween. This evenly distributed force over a large surface area of continuous substantially parallel contact surface against inserted currency or paper, allows for a much more secure engagement between the planar members. Further, the even and widely communicated force provides a means for a much easier user-insertion and removal of paper or currency from the biased engagement. This is because all the force of the biased opposing members is not concentrated at distal ends in a very small surface area as in the current art. This evenly distributed force of the contact surfaces with substantially the entire surface of inserted medium in communication with the contact surfaces, increases proportionally with the amount of displacement or separation of the opposing contact surfaces from each other.

The opposing planar segments of the disclosed device as noted may be formed in various patterns or shapes of bent wire or of metal or polymeric material, such as triangular or round or rectangular. When formed of wire-like members, such planar portions or segments may also be joined to the formed planar components which act as extensions or entities of the planar segments becoming an extension of the planar member which then evenly distributes a compressive bias. Contact surfaces of planar members in either mode, may be smooth or possess a coarse finish such as gnarling, to alter the frictional resistance to a sliding movement with respect to flatly formed items placed within. In some cases, one planar member of the aforementioned clip system may be a base plate or larger surface such as a table, desk or clipboard.

A highly advantageous characteristic of this improved device and the disclosed cross-over parallel method of applying a compressive sandwiched bias to paper and banknotes is derived from the continuously parallel properties of the planar members from contact to maximum separation distance. When the clip is expanded by user performed displacement of planar members, or by the containment of items, the planar members remain substantially parallel throughout the translation to and from maximum separation distance. By substantially parallel it is meant that the two contact surfaces of the two planar members will be continuously parallel or within a few degrees of parallel throughout the distance of translation to and from a maximum separation. Slight deviations may occur due to user force or the shape of the inserted paper or currency or medium, however the two contact surfaces of the planar members will continuously try to remain parallel or return to parallel once force by the user ceases.

Depending on the size, weight and material properties of the items to be contained, multiple mechanisms yielding this biased sandwiched engagement of two parallel contact surfaces may be employed in an array of one or more as part of an arranged pattern to distribute the compressive bias across larger or oddly shaped objects. Also, in certain situations, a grommet-like addition may be applied, molded or formed at the cross-over intersection of substantially perpendicular spring-like members to limit or constrain deformation and relative displacement. The cross over spring-like members while generally are perpendicular to the contact surfaces of the planar members, this may vary by slight curvatures of the spring-like cross over members, or flex during use.

The disclosed device herein, employing this “cross-wire” configuration as noted, provides many advantages and uses over the conventional design which are illustrated in the descriptions following and discernible from the drawings. It is briefly noted that the features and advantages of the device can be employed in a plurality of other designs employing a bend member and cross-over configuration where it can be implemented, such as money clips, paper clips, and clamps for holding heavier things such as two wooden 2×4's together.

Again, the device employs a particularly preferred cross member configuration of a unitary formed member or wire-like members. In the as-used mode of the device, a plurality of the member or wire portions, preferably two portions of wire herein referred to as ‘spines’ or ‘cross members,’ cross at a terminating or limiting edge of the material being held by the device, forming the depicted cross-over or X-shape. The opposing distal end portions of the crossed members include leg portions extending therefrom which are bent relative to other portions but occupy substantially the same plane which is substantially orthogonal to the plane of the cross members and each form respective overlapping planarly aligned leg configurations with respective contact surfaces.

In use, each of the spine portions of the member undergo a deformation during insertion of money or media and provide a means for torsional loading, that is they act as a type of torsion bar, such that when loaded (i.e. when the device is opened and contact surfaces separated to receive the medium to be held, or when the spines are pre-loaded or pre-stressed to impart force to the contact surfaces when collapsed) each spine is twisted and/or slightly bent, and formed of material which resists this deformation at a force to impart and communicate a closing bias to the contact surfaces. The deformation and resulting return force results in the communication of a bias or means for compressive sandwiched engagement of inserted medium such as currency between the opposing biased contact surfaces. Further, an enhanced gripping of the contact surfaces is provided by the biased engagement from the resultant restoring torsional forces of the spines when deformed which is communicated to the overlapping gripping planes of the contact surfaces of the leg portions, or engaged members thereto.

Advantages of this configuration and the resulting biased contact surfaces against the material held is that the material being held is substantially restrained by the biased sandwiched engagement from twisting or sliding between the contact surfaces. Further, the provision of two cross members engaging the edge of the medium being held, as opposed to one spine section, provides a means for aligning and restraining the edge of the medium when inserted. In addition, the cross wire configuration of the overlapping members also makes the clip structure itself much more torsionally stable, allowing it to be used more effectively in devices such as a money clip. This torsional stability of the device and the contact surfaces can be further improved by other preferred modes of the device which employ a boxed configuration, that is, all free ends of the member or wire forming the device are secured.

In general, when the formed device is under a load, or when the spines are pre-stressed under a load, the ends of the spines at or near the four corners of the X-shaped cross wire configuration provide moments of torqued engagement which are then communicated to the leg portions. This results in a means for compressive sandwiched engagement of the opposing planar leg configurations forming contact surfaces for clamping a material therebetween. Further, this configuration allows the contact surfaces of both engaged planar members or segments, to maintain a substantially parallel positioning, throughout their sequential translation in different imaginary planes from a collapsed configuration in mutual contact to a maximum separation and maximum distance between the contact surfaces. While the planar surfaces providing the contact surfaces may momentarily tilt slightly from mutually parallel, if the material being constrained is planar such as paper or money or bank notes, the two contact surfaces on contact with the constrained material will return to a substantially parallel positioning where substantially all of the surface area of both contact surfaces will touch the constrained material.

Further, the cross wire configuration of spring-like members, positioned substantially normal to the contact surfaces, substantially increases the compressive force that is applied to the inserted material. This is because torsion from two cross wires is communicated to each respective contact surface rather than just a single member as in the previously cited prior art. Further, the continuously parallel positioning of the two sidewalls of the device, and contact surfaces, provide a low profile to the device when constraining money or similar media which in use, is only slightly larger than the material it is holding, whether the material is very thin or very thick.

In accordance with at least one preferred mode, the planarly aligned leg portions of the formed device are bent in their communication from the cross-over members and formed into opposing right triangles, each of which has one of two opposing contact surfaces. Briefly, this mode of the device is configured with a small gap formed between the respective projecting points of the triangles. This gap provides an insertion target and easier separation when the user secures the device to the paper or other material. It is noted however that in other preferred modes of the device, the gripping planes of the leg portions may be formed in other configurations of the bent leg portions, and consequently should not be considered limited to a bending of the wire-like member to right triangles. For example, the leg portions may form substantially trapezoidal or square shapes or as noted, may be engaged with formed sidewalls of metal or polymeric or hybrid materials.

In yet another preferred mode, each of the planarly aligned leg configurations formed by the bent leg portions are enclosed in an engagement with a respective sidewall body component. The body components preferably include at least one substantially flat contact surface which may be textured or otherwise formed to enhance the frictional gripping force of the device to the material being held. In this mode the sidewall components may be formed to provide novel and functional money clips. The body of one or both sidewall components can be ornamentally formed, and may include indicia in the form of printed, engraved or otherwise formed indicia which is customizable by the manufacturer. As such, the user will be able to employ the benefits of the cross wire configuration and continuously parallel positioning of the sidewall components along with the improved gripping means of the body components, thereby providing an vast improvement in the art of money clips. The indicia can be customized to the individual user, or be a form of advertisement or logo which companies can use as an advertising or promoting means.

In still yet another preferred mode of the present invention, the device is configured as a clamp which may be employed for woodworking, construction, or other purposes. It is noted that in this mode, the device may be formed from wire of substantially higher gauge in order to provide gripping forces which are suitable for these purposes. Additionally, the cross members may include spring portions, such as torsion springs, to further enhance the resultant compressive force when the device is loaded. Still further, double and triple cross wire configurations employing a plurality of crossing spine portions are also disclosed and described below.

With respect to the above description, before explaining at least one preferred embodiment of the herein disclosed invention in further detail, it is to be understood that the invention is not limited in its application to the details of construction and to the arrangement of the components in the following description or illustrated in the drawings. The invention herein described is capable of other embodiments and of being practiced and carried out in various ways which will be obvious to those skilled in the art. Also, it is to be understood that the phraseology and terminology employed herein are for the purpose of description and should not be regarded as limiting.

As such, those skilled in the art will appreciate that the conception upon which this disclosure is based may readily be utilized as a basis for designing of other structures, methods and systems for carrying out the several purposes of the present disclosed device. It is important, therefore, that the claims be regarded as including such equivalent construction and methodology insofar as they do not depart from the spirit and scope of the present invention.

As used in the claims to describe the various inventive aspects and embodiments, “comprising” means including, but not limited to, whatever follows the word “comprising”. Thus, use of the term “comprising” indicates that the listed elements are required or mandatory, but that other elements are optional and may or may not be present. By “consisting of” is meant including, and limited to, whatever follows the phrase “consisting of”. Thus, the phrase “consisting of” indicates that the listed elements are required or mandatory, and that no other elements may be present. By “consisting essentially of” is meant including any elements listed after the phrase, and limited to other elements that do not interfere with or contribute to the activity or action specified in the disclosure for the listed elements. Thus, the phrase “consisting essentially of” indicates that the listed elements are required or mandatory, but that other elements are optional and may or may not be present depending upon whether or not they affect the activity or action of the listed elements.

It is an object of this invention to provide a money or paper clip, which has opposing sidewalls with contact surfaces imparting a biased sandwiched engagement to inserted paper or medium.

It is a further object of this invention, to provide such a device with such sidewalls which remain or return to positions substantially parallel to each other throughout a translation from contact with each other, to a maximum separation distance.

These objects, and other features, and advantages of the invention will be brought out in the following part of the specification, wherein detailed description is for the purpose of fully disclosing the invention without placing limitations thereon.

### BRIEF DESCRIPTION OF DRAWING FIGURES

The accompanying drawings, which are incorporated herein and form a part of the specification, illustrate some, but not the only or exclusive, examples of embodiments and/or features. It is intended that the embodiments and figures disclosed herein are to be considered illustrative rather than limiting. In the drawings:

FIG. 1 shows a perspective view of a particularly preferred mode of the clip or clamping device formed from a single piece of metal wire, employing a cross wire configuration and two formed sidewalls, which is especially well suited as a paper clip or money clip.

FIG. 2 shows a rear view of device of FIG. 1 detailing the spine portions of the bent member or wire forming the cross wire configuration engagement of the two formed sidewalls.

FIG. 3 shows the device of FIG. 1 in an as used-mode as a paper or money clip depicting a first position for engaging the device onto a stack of material.

FIG. 4 shows a second position wherein the member forming the device undergoes a deformation where it is twisted and may bend to splay open the distal ends of the leg portions forming the opposing sidewalls.

FIG. 5 shows a final as used position wherein the device is translated over the material such that the spine portions of the member undergo deformation where they are in a twisted or in a loaded state which communicates a bias or compressive force onto the material and to the formed sidewalls, to effectively clamp the device thereon.

FIG. 6 shows a rear view of the device in the as used mode detailed the cross wire configuration and four moments of torqued engagement, and a return of the contact surfaces of the formed sidewalls to their substantially parallel positioning.

FIG. 7 shows a view of another preferred mode of the invention wherein a sleeve is engaged over the distal ends of the single member or single piece of metal wire forming the device.

FIG. 8 shows a view of still another particularly preferred mode of the member-formed clamping device formed from two members or pieces of metal wire.

FIG. 9 shows the mode of the device of FIG. 8 however with cap portions engaged over the terminating ends of the two members provided by pieces of wire.

FIG. 10 shows still yet another particularly preferred mode of the device formed from a single piece of metal wire and having the respective leg portions forming sidewalls bent into a substantially rectangular shape.

FIG. 11 shows another preferred mode of the device wherein at least one spine portion employs an offset, or jogged portion.

FIG. 12 shows a top view of the mode of FIG. 11 further showing the jogged portion of the outer spine.

FIG. 13 shows a view of still yet another preferred mode of the device formed from a single piece of wire, having the leg portions bent into a substantially trapezoidal shape, and employing removably engageable body components which configures the device for preferred employment as a money clip.

FIG. 14 shows the device of FIG. 13 in an engaged position with the body portions forming a money clip.

FIG. 15 is another preferred mode of the device formed from two pieces of wire.

FIG. 16 shows a top perspective view of a body component configured for engagement with the mode of the device of FIG. 15.

FIG. 17 shows a bottom perspective view of FIG. 16.

FIG. 17a shows an end view of a preferred body component having a substantially curved profile, which allows the device when employed as a money clip to contour to the curve of a users leg when in the pocket of the user.

FIG. 18 shows the device of FIG. 15 engaged to two of the body components of FIG. 16 which configures the device as a money clip.

FIG. 19 shows a mode of the device employed as a clip device.

FIG. 20 shows a rear view of FIG. 19.

FIG. 21 shows a view of still yet another preferred mode of the device formed from a single piece of wire and having the leg portions bent in a curvilinear fashion.

FIG. 22 shows a mode of the device which is especially well suited for employment with the clamping component of FIG. 23.

FIG. 23 shows a view of a particularly preferred clamping component which may be employed with the formed member or wire configuration of FIG. 22.

FIG. 24 shows another mode of the device of FIG. 23 engaged to the clamping component of FIG. 22 using a handle to twist it to an open position.

FIG. 25 shows a view of yet another mode of the device employing a double cross over member configuration and torsion spring portions for enhancing the gripping power of the device such as would be desirable with thicker or heavier constrained items.

FIG. 26 shows a side view of the device of FIG. 25.

FIG. 27 depicts a perspective view of the members forming the base device configured to form sidewalls at distal end portions, in a square or rectangular variant communicating in a plane normal to the cross-over of vertically disposed portion of the members.

FIG. 28 depicts a perspective view of a mode of the device with member-formed sidewalls or supports for engageable planar sidewalls, which are formed to a triangular variant. This triangular configuration yields an especially stable clip which is easier to insert money or paper between sidewalls.

FIG. 29 is a perspective view of the device having sidewalls formed of plastic, metal, or hybrid material at their closest or contact point, having the biased force communication from the rectangular formed members of FIG. 27 which are situated in channels to enhance the biased sandwiched engagement and torsional stability.

FIG. 30 is a perspective view of the device which employs the member configuration of FIG. 27, and showing the continuous substantially parallel positioning of the sidewalls and contact surfaces during translation through sequential planes in a direction away from each other to the depicted expanded position.

FIG. 31 is a view showing the cross-over member configuration with engaged planar sidewalls in a position normal to the plane of the intersecting spring-like members while in an expanded configuration.

FIG. 32 depicts another view of the continuous substantially parallel positioning of the contact surfaces and engaged sidewalls of FIG. 31.

FIG. 33 depicts an end view of the contact surfaces and opposing biased planar sidewall members while expanded, and including an arched pathway connection between crossed members at the cross over point of communicating wire-like members.

FIG. 34 is a perspective view of a typical prior art money clip having non parallel sidewalls and a small partial contact surface area at distal ends which provides a small contact surface to inserted medium, paper, or currency.

### DETAILED DESCRIPTION OF THE PREFERRED EMBODIMENTS OF THE INVENTION

In this description, the directional prepositions of up, upwardly, down, downwardly, front, back, top, upper, bottom, lower, left, right, normal, perpendicular, and other such terms refer to the device as it is oriented and appears in the drawings and are used for convenience only. Such terms are not intended to be limiting or to imply that the device cannot be used or positioned in any other particular orientation.

The various components of the device disclosed herein can be formed of conventional materials for elongated members such as metal wire, spring steel, or the like, or hybrid materials such as resin and fiber, or the members and attachments thereto can be formed of any material suitable for the purposes set forth in this disclosure.

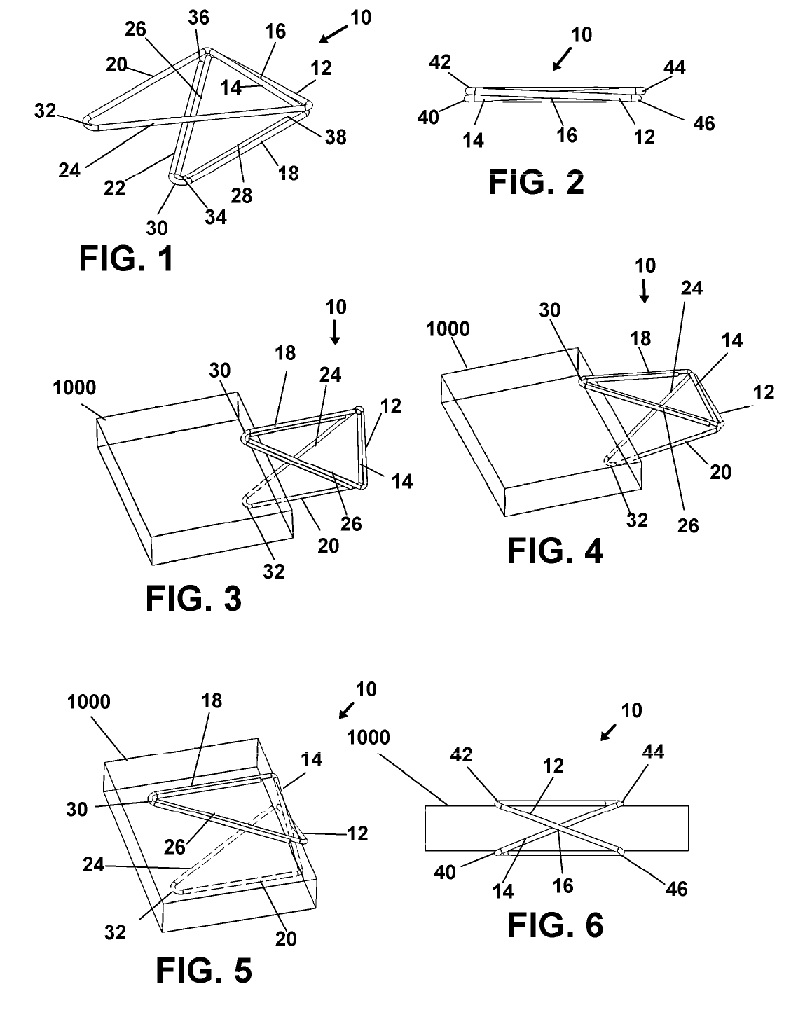

Now referring to drawings in FIGS. 1-33, wherein similar components are identified by like reference numerals, there is seen in FIG. 1 and FIG. 2 a first particularly preferred mode of the clamping device 10. A single member shown as a piece of metal wire, similar to that employed conventionally for the common paper clip or other suitable material, is bent or otherwise configured so that it has an outer spine 12 and an inner spine 14 which cross each other at 16, thus provided the above noted cross over or cross wire configuration.

There are two outer side legs 18 and 20 formed of portions of the member forming the device 10 which are preferably bent substantially perpendicular to the plane occupied substantially by the outer spine 12 and inner spine 14 as shown. The member provided by the wire is further bent to provide two outer diagonally running leg portions 22 and 24, one inner diagonally running leg portion 26 and one inner side leg end 28, which is shown extending substantially parallel to outer side leg 18.

The outer diagonally bent end portion 22 is bent approximately 45 degrees relative the adjacent side leg 18 at a first distal end 30 of the device 10 and terminates 36 near the side leg 20. The outer diagonally bent end portion 24 is bent approximately 45 degrees relative the adjacent side leg 20 at a second distal end 32 of the device 10 and continues to the outer spine 12. It is noted however, that the leg portions can be bent at other degrees, and are anticipated. The inner diagonally bent leg portion 26 communicates from an engagement with the end of the outer spine 12 to an approximately 45 degree bend 34 adjacent the first distal end 30, which then extends along the inner side leg end 28 parallel to the outer side leg 18 to a second termination 38 of the wire.

As can be seen the outer side leg 18, inner side leg 28, outer diagonal leg 22, and inner diagonal leg 26 are aligned to form a first planarly aligned leg configuration, and is substantially triangular in shape. The outer side leg 20, and outer diagonal leg 24 align in a second planarly aligned leg configuration, and is also substantially triangular in shape, and overlaps the first plane. In the as used mode described shortly, when the device 10 is loaded such that a deformation of the spines 12, 14 occurs when they are twisted much like torsion bars, the resultant restoring forces of the spines 12, 14 are communicated as an inward bias to the leg portions of each respective formed planar configurations and providing a means for compressive gripping of material between the gripping planes formed by the legs of the device 10. In essence, torsional moments at or near the corners 40, 42, 44, 46 of the cross wires 12, 14 when under a load during deformation caused by media insertion and provide at least four means of biased or torqued engagement of the device 10 to the medium being held. The bias from this deformation is then communicated to the respective legs forming the respective contact surfaces, providing the means for a biased or compressive sandwiched engagement of the material. This will become apparent to those skilled in the art upon further disclosure of the preferred modes of the device 10 described later.

It is noted that in this mode the terminating ends 36, 38 of the wire are positioned such that during operative employment of the current mode of the device 10 as a money clip or paper clip, the ends will not dig or damage the material being held. This overcomes the downfalls of conventional and prior art devices which may tend to dig the typically sharp ends into the material being held. However, it is noted that length of the leg end portions 22, 28 and therefore the position of the terminating ends 36, 38, may be adjusted and modified into other configuration which will be set forth in later figures.

In the current mode it is additionally preferred that the outer spine 12 and the inner spine 14 are approximately the same length, which are approximately the same length as the side legs 18, 20, and 28. However, those skilled in the are will realize that the size of the clip can vary according to use and is anticipated. For example the spines 12, 14 can be approximately one inch, the side legs 20, 18 one inch and the bent diagonal portions 24, 26 one inch. The diameter of the wire used and the sizes may be varied according to desire and resulting compressive strength of the device 10 in the as used mode, described shortly. The material of the wire can be that used for the common paper clip but other material such as, but not limited to, stainless spring steel and music wire similar that used in common compression springs, and other suitable materials.

In FIG. 3, FIG. 4, FIG. 5, and FIG. 6, the device 10 shown in a preferred as used mode for clipping together or otherwise engaging some medium, such as a stack of money or papers 1000. The device 10 is configured such that members forming the spines 12 and 14 cross at the edge of the stack 1000 (FIGS. 5 and 6). This engagement allows for a significantly larger area of contact with the restrained stack 1000 than the small area of contact of conventional devices (FIG. 34) which only employ a single spine and angled contact surfaces, such as the previously cited U.S. Pat. Nos. 4,949,435, 2,061,474; 1,989,953; 1,783,099; and 776,974. This cross wire configuration herein, also provides a means for added support of the material being held and a means for aligning the edge of the stack of papers 1000.

FIGS. 3, 4 and 5 show the sequence of applying the device 10 formed as a unitary structure from a serpentine-configured member, to a stack of papers 1000. First the device 10 is positioned perpendicular to the stack 1000 and oriented such that the stack 1000 communicates between a gap providing an insertion target at distal ends 30 and 32 of the formed triangular sidewalls as shown in FIG. 3. The opposing contact surfaces of the device 10 are then twisted and a momentary splaying open of the ends 30 and 32 is achieved as shown in FIG. 4. As the device 10 is being twisted in a deformation of the member, the resistance to this deformation is communicated to the contact surfaces of the formed sidewalls which are biased or being pushed onto stack 1000 from opposing sides. Insertion will continue until the crossing spines 12, 14 which form a stop, contact the edge of the stack 1000 of media as shown in FIG. 5 and FIG. 6.

This insertion causes a separation of the corners 40, 42, 44, 46 of the spines 12, 14 such that the spines 12, 14 formed by the member in a unitary serpentine configuration, undergo deformation or a torsional loading. Once the device 10 is pushed all the way onto the stack 1000, both contact surfaces of the formed sidewalls return to a substantially parallel positioning which is maintained to a maximum separation distance. By substantially parallel is meant that both contact surfaces are finally positioned along planes which are parallel or within 1-6 degrees of angle to each other of being parallel. As a general rule, if the opposing sides of inserted media such as money or bank notes, are planar, both contact surfaces will assume a parallel positioning where they contact and follow the plane on their respective side of the inserted media. Since most banknotes or paper money is substantially flat even when folded in half, both contact surfaces will be substantially at zero degrees in parallel planes, or within 1 to 6 degrees of being parallel.

Thus, the substantially planar and parallel contact surfaces are positioned on one side of the perimeter of the first planarly aligned leg configuration of the member forming leg portions 18, 28, 22, 26 and upon an opposing side surface of the second planarly aligned leg configuration of the member forming leg portions 20 and 24, and the perimeter thereof. Both opposing contact surfaces will always return to their substantially parallel positioning, with a majority of their contact surface areas within the perimeter of the respective leg, contacting the respective side surfaces of the inserted media or stack as shown.

The deformation of the member and resulting torsional loading of the spines 12, 14 and restoring moments at or near the four corners 40, 42, 44, 45 resulting thereof, impart a bias to respective member portions which is communicated to the respective contact surfaces provided by the perimeters defining the formed leg portions. This bias results in a compressive force of the opposing contact surfaces against sides of the inserted media or stack 1000. Because of the planar nature of the formed contact surfaces, and their propensity to maintain a substantially parallel positioning, substantially all of the surface area of the respective opposing contact surfaces will make contact with the planar opposing side surfaces of the inserted media or stack 1000. By employing these four means of torqued engagement caused by member deformation, essentially double the amount of biasing force may be achieved in the sandwiched engagement relative to conventional and prior art devices which only employ a single spine member, and a very small contact surface area of the total available contact surface.

It is noted that the device 10 can be made from conventional manufacturing techniques known in the art where a single member is bent or configured to shape in a serpentine path to form a unitary structure of a single bend-resistive member.

It is additionally noted and anticipated that although the device is shown in a number of simple forms, various components and aspects of the device may be differently shaped or slightly modified when forming the shape of the invention herein. As such those skilled in the art will appreciate the descriptions and depictions set forth in this disclosure or merely meant to portray examples of preferred modes within the overall scope and intent of the invention, and are not to be considered limiting in any manner. Although the mode of the device 10 has been shown to provide substantial improvements in the art of restraining or clamping devices, money clips, and paper clips, additional preferred modes of the device are described herein having different configurations. However all employ a cross wire or cross over member configuration noted herein which provides the deformation to impart bias as well as maintaining a continuous parallel positioning of contact surfaces.

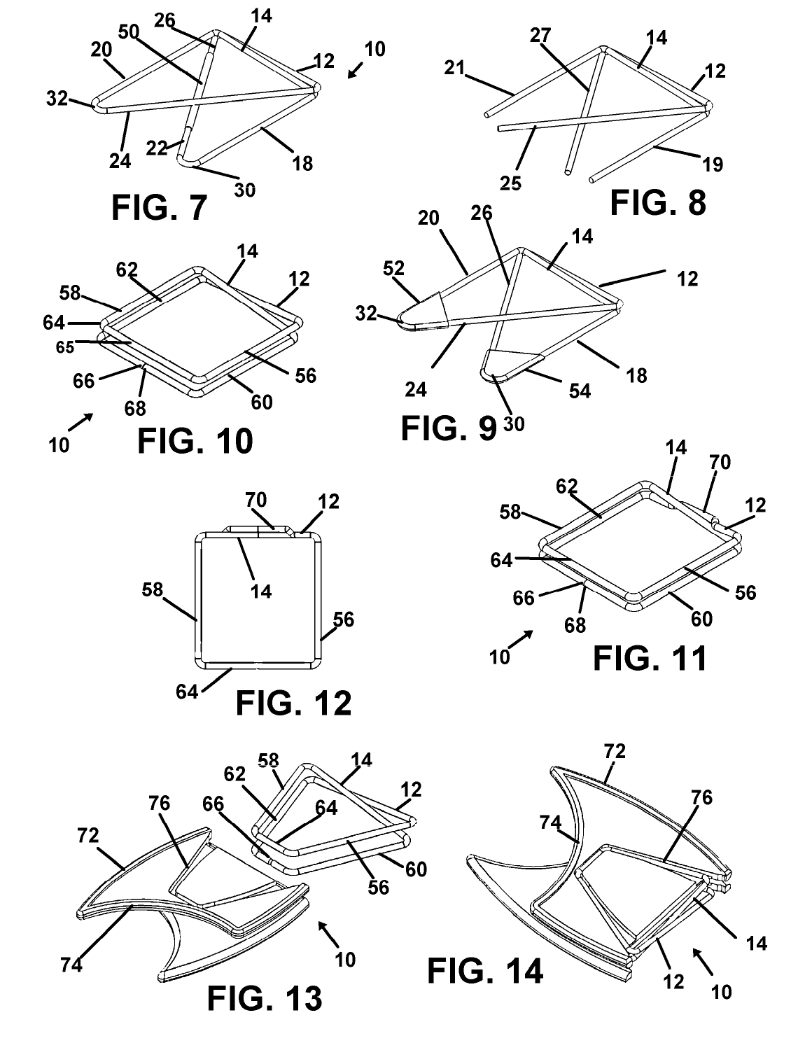

FIG. 7 shows a view of another preferred mode of the device 10, similar to the previous mode, however not including the inner side leg portion 28, and having inner and outer diagonal leg portions 22, 26 which are substantially shorter. In this mode the terminating ends (not shown in the figure) of the diagonal leg portions 22, 26 are engaged within a cylindrical sleeve 50. This mode reduces the need to form the additional bends or curves forming the inner side leg and also creates a box configuration providing means for enhance torsional stability of the device 10, due to the retrained distal ends. The sleeve 50 may be made from metal, rubber, or plastic tubing which is engaged over the ends during manufacture, or may be other suitable meas for engaging the ends, such as s crimp or the like. Additionally, the sleeve may be a shrink wrap tube which engaged over the ends then heated and shrunk to form a tight fit. This mode is especially preferred since there are no free ends of the wire which can dig into the material it is engaging.

FIG. 8 and FIG. 9 show another mode of the device 10 formed from two pieces of wire instead of the depicted unitary structure of a single member or wire. In this mode, a first member or piece of wire comprises the outer spine 12 and both diagonal leg members 27, 25, while the second member or piece of wire comprises the inner spine 14, and both outer leg portions 19, 21. The free ends of the two members can be capped 52, 54, such that the device 10 resemble the unitary structure mode of the device 10 of FIGS. 1 and 7.

FIG. 10 shows still another mode of the device 10 wherein all side leg portions 56, 58, 60, 62 are configured or bent substantially orthogonal to the plane of adjacent crossing spines 12, 14. A top leg portion 64, and inwardly bent distal end portions 66, 68 extending parallel to the top leg 64 are also provided such that the device 10 is substantially rectangular in shape. As can be seen a first 56 side leg, second 58 side leg, and top leg 65 are aligned in a first planarly aligned engagement plane, while the third side leg 60, fourth side leg 62, and inwardly bent distal ends 66, 68 are aligned in the overlapping second planarly aligned engagement plane. Again, in use, these planarly aligned configurations will tend to lie flat against the surfaces of the medium being held, such as was shown previously in FIGS. 5 and 6. It is noted that in other modes, the distal ends 66, 68 can be engaged together by welding, adhesive, or may employ a sleeve component such that the ends will not protrude or possible damage the medium being held. This substantially normal positioning of the contact surfaces to the plane of the cross-over of the members providing the biasing force, and the parallel contact of the contact surfaces with the money or media, renders the device in its most compact form once money or media is engaged between the contact surfaces and thus occupies less space in a pocket or purse.

FIGS. 11 and 12 show another mode of the device 10 wherein the outer spine 12 includes a jogged or offset portion 70. It is noted that the provision of the offset portion 70 can be included on any of the preferred modes of the invention and is not to be considered limited by the current depiction. The offset portion 70 is preferred in that the spines 12, 14 will be aligned (FIG. 12) and will not substantially project from the edge of the material being held, as compared to the previous mode of the device 10 wherein the spines 12, 14 simply overlap. Further, this allows the majority of both spines 12, 14 to engage the edge of the material being held, providing a means for aligning and securing the edge thereof. Other advantages may be recognized by those skilled in the art and are anticipated.

FIGS. 13 and 14 show yet additional modes of the device 10 formed of a unitary structure of the serpentine member in a substantially trapezoidal shape. As such the side legs 56, 58, 60, 62 are formed substantially inwards as opposed to orthogonally relative the spines 12, 14. Also included in this mode, are removably engageable planar body components 72, formed of plastic, metal, or other suitable material, which have complimentary shaped recesses or cavities 76 which provide means for engagement to the formed shapes of the two sides of the depicted device 10, to thereby configure the device 10 as a money clip. The body components 72 include the cavity 76 which is configured in a shape complimentary to the configuration of the legs as shown. Engagement of the body components 72 to the device 10 can be provided by the positive engagement of the compressive forces of the device 10 itself to depend into and remain in the cavity 76 of each of the body components 72. However, the engagement can be made permanent by welding, adhesive, or the like to maintain this complementary engagement within each respective cavity 76. It is noted that in other modes, the shape and configuration of the cavity 76 formed in one side surface of the body component 72 may be modified to be shaped complimentary to the formed shapes of leg portions in other modes of the device 10 having differently configured leg portions. Therefore, the depicted shapes of both leg portions and complimentary cavities 76 should not be limited to the trapezoidal shape shown.

In use, the body components 72 will effectively increase the surface area of the engagement surface of the device 10 with the material being held, wherein in other modes of the device 10 only one side surface of the member forming the perimeter defining the legs of the device 10 are in contact with the material being held. As such the planar body components 72 provide a means for enhancing the engagement of a contact surface of the device 10 against the material or media held. Further, the body component 72, having a contact surface provided by the inner edge 74 which is angled or substantially curved allows the user to engage the provided contact surfaces of device 10 to a stack of paper or other material by employing the steps shown in FIG. 3-5. Other preferred modes of removably engageable body components which provide both ornamental and contact surface enhancement, are shown in later figures.

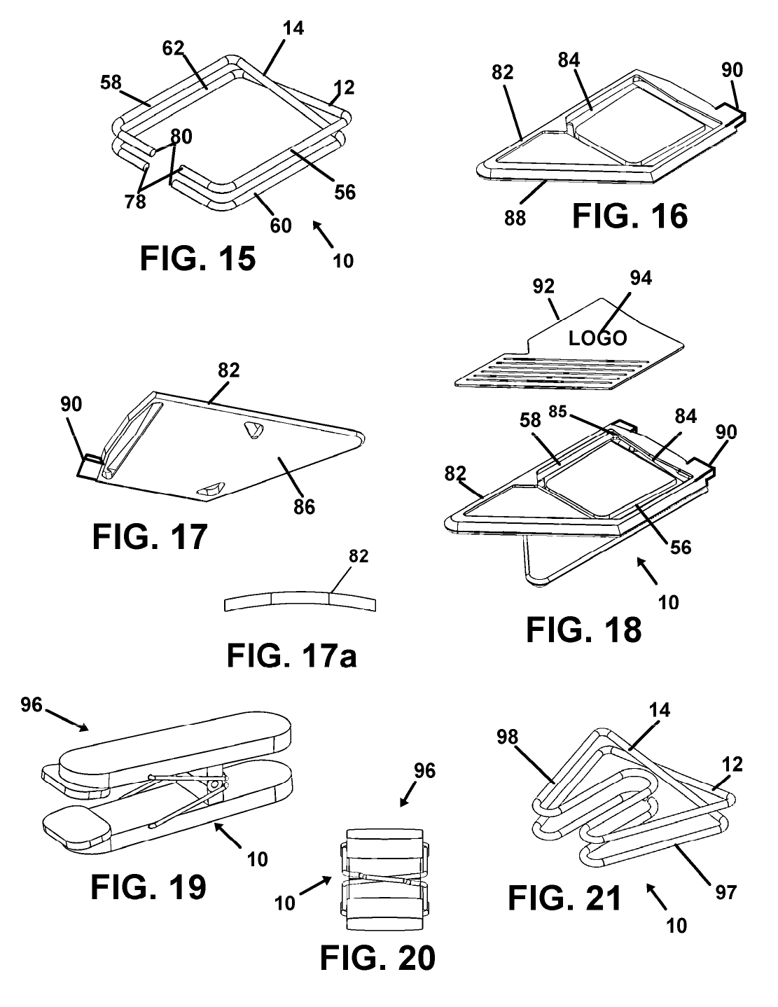

FIG. 15 shows another mode of the device 10 formed from two individual wire-like members. In this mode, a first wire-like member comprises the outer spine 12, having two side leg portions 56, 62, while a second wire like member, forms the crossing inner spine 14, and remaining side legs 58, 60. Further, the distal ends 78, 80 of the portions of wire-like members are bent inwardly at substantially 90 degrees relative the side legs 58 and 60, as shown.

FIGS. 16 and 17 show views of another particularly preferred removably engageable body component 82 having an angled edge 88, and showing a substantially planar contact or engagement surface 86, which in use, provides a means for enhancing the frictional engagement of the device 10 to a material being held. As such the surface 86 providing the opposing contact surfaces, may be textured such as knurling, or coated or otherwise formed with a friction enhancing material, such as a rubber coating. Again, channels or cavities 84 are provided in shapes complimentary to the perimeter shape of the member on opposing sides, as a means for registering the engagement of the body 82 with the wire-like member of the formed device 10.

Further, in this mode the secured engagement of the device 10 to the body components 82 can be provided by the positive engagement of the inward bias or compressive forces of the device 10 itself, provided by member deformation described earlier, which is communicated to the body components 82. Lip portions 85 are provided to further secure the device 10 to the body components 82 by restraining the distal corners of the device 10, as can be clearly seen in the figure. However adhesives, welding, or the like can be employed to enhance engagement of the member and provide a permanent engagement.

It is again noted that those skilled in the art will recognize that the current depicted mode of the body component 82 may be modified to be employed with other shapes of the members and other preferred modes of the device 10, and as such should not be considered limited by the current depiction. Further, as shown, the body components 82 include tab portions 90, which the user can engage with their thumb and forefinger, and thereafter can impart a twisting motion thereon. Thus the tab portions 90 provide a means for aiding the user to part the biased contact surfaces and achieve the engaged mode of the device 10 to the biased sandwiched engagement with medium being held when employing the steps shown in FIGS. 3-5.

In addition, the planar body components 82 can include a cover 92 having indicia 94 imparted thereon such as a logo, name, image, picture, or the like. The indicia 94 can be applied by printing, engraving, carving, etching or other suitable forming means. For example the indicia 94 can be a company logo, wherein the device 10 is employed as a means for advertising, and the like. Alternatively, the device 10 can be customized by the individual user by having indicia 94 of the users name formed thereon. The cover 92 can be engaged by welding, snap fits, adhesive, or other suitable means for engagement.

FIG. 17a shows an end view of yet another mode of the body component 82 having a substantially curved profile. As such, when employed as a money clip, the device 10 will be contoured to the curve of the users leg when stored in the users pocket and provide a means for bending or contouring the material being held, such as paper currency or credit cards. Therefore the device 10 and the material being held will more comfortably rest in the users pocket when stored. It is noted that those skilled in the art will realize that any of the modes of the device 10 may similarly be curved or formed in such a manner to provide a contoured configuration as needed, and should not be considered limited to the current depiction only.

FIGS. 19 and 20 show still yet another preferred mode of the device 10 employed using the cross over configuration of the member in an engagement with a clip 96. In this mode the device 10 using the cross over configuration is engaged to opposing sides of the clip 96 and deformation of the members forming the device 10 provide the inward bias to the opposing halves of the clip 96.

It is noted that it is an object of the invention to employ the cross over configuration of a unitary member or a plurality of members engaged with clips and forming the spines 12, 14 providing the inward bias upon deformation as previously described. This configuration whether in combination with a clip 96 or other side surfaces provides a significant improvement of the engagement of the contact surfaces with a medium being held. This formed biased sandwiched engagement and contact of substantially all of the area of the parallel-positioned contact surfaces of the device 10 with the held material, yields a vast improvement over prior art devices with small contact surface areas of angled members.

Further, those skilled in the art will understand that the members forming the leg portions extending from members forming the spines 12, 14, can be bent and configured into essentially any shape or form, without departing from the scope and intent of the invention. As an example, shown in yet another preferred mode in FIG. 21, the cross wire configuration of the spines 12, 14 is provided where the sections forming legs 97, 98 are bent in a curvilinear fashion to form sidewalls and contact surfaces as can be clearly seen.

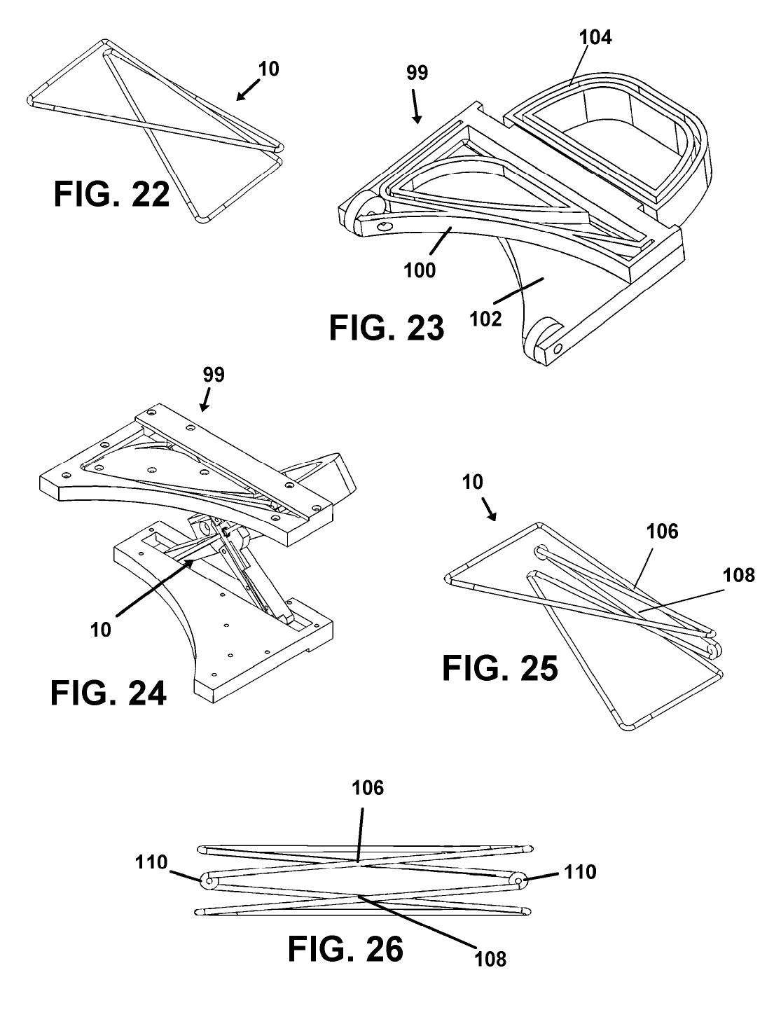

FIG. 22 show still yet another preferred mode of the device 10 which is especially configured for engagement and employment with the clamping component 99 augmenting the device 10 such as that depicted in FIG. 23. The clamping component 99 has two arm portions 100, 102, an a rotatably engaged handle 104 which is adapted with connecting linkage. The device 10 is operatively engaged to the clamping component 99 such that the members forming the device 10 acts as a spring to bias the arms 100, 102 into a closed positioned. From this closed position, the handle 104 can be rotated to provide a means for opening the device 10 as shown in FIG. 24 by releasing the biased sandwiched engagement. This mode of the device 10 can be scaled larger than modes of the device 10 used for money clips or paper clips, such that the clamping component 99 can be employed for woodworking or the like. As such the member or wire forming the current mode of the device 10, may be a substantially higher thickness or gauge wire than that of the previous modes.

FIGS. 25 and 26 show still yet another preferred mode of the device 10 wherein the members forming the spines cross at least twice 106, 108, herein providing a double cross over configuration formed by wire-like members or members sized to the task. Those skilled in the art will recognize that additional plurality of crossing spines formed by the second cross-over of members, may be configured such that a triple cross wire configuration and higher can be provided. Further, springs 110, such as torsion springs, engaged to the spines are also shown which provide a means for increasing the compressive force of the sidewalls engaged with the device 10 when in the as-used mode. In addition, the springs 110 are preferred in that the larger gauge wire may tend to deform and yield and employing them prevents yielding while still providing the required torque. It is noted that the provision of springs 110 can be employed in any mode of the device 10 and should not be considered limited by the current depiction.

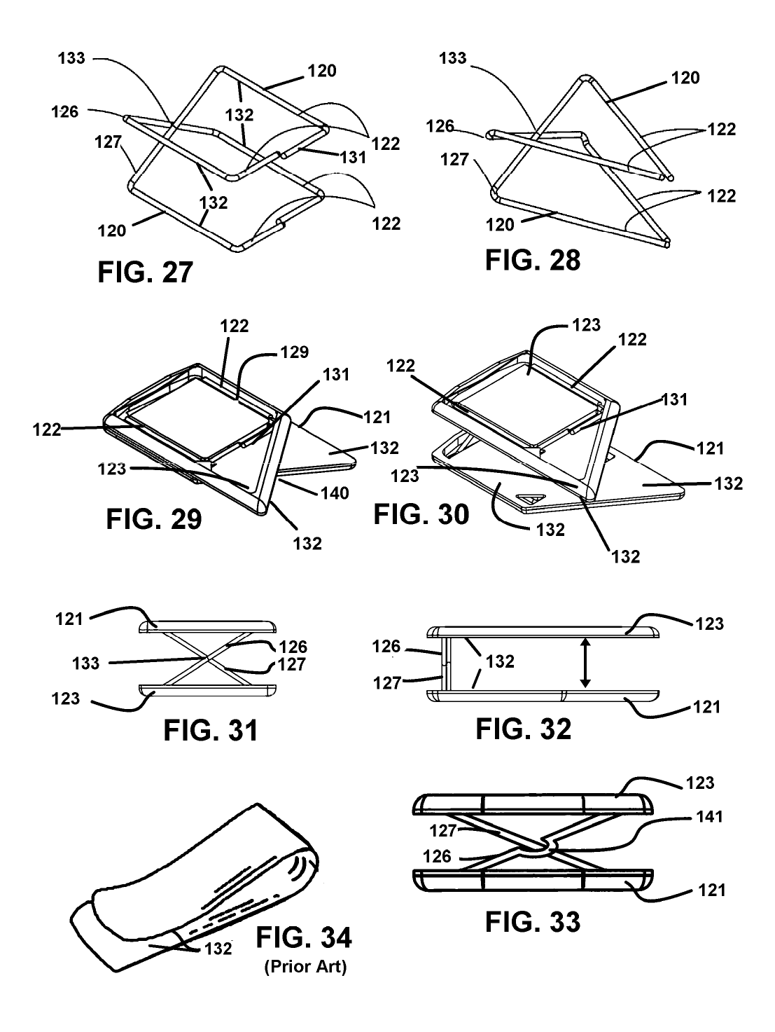

In FIG. 27 there is shown a perspective view of the device 10 having the members forming the device 10 configured at distal portions 122 to formed substantially perpendicular sidewalls 120 by a bending of distal end portions 122 of the members extending from the perpendicularly positioned cross over 133, in a square or rectangular configuration. Also shown is the cross over 133 of members of the outer spine 126 and inner spine 127 which both respectively communicate with respective formed distal portions 122, and thereby communicate the biased compressive force to the formed sidewalls 120, when their respective contact surfaces touch each other or are separated as in FIGS. 31-33. The formed sidewalls 120 providing the contact surfaces for inserted material are shown substantially in a plane normal to the plane occupied by the members forming the inner spine 127 and outer spine 126, and maintain this substantially parallel positioning relative to each other, during positions of translation from a contact with each other, to a maximum separation from each other after momentary varying during insertion or removal of held material such as money.

FIG. 28 depicts a perspective view of the device 10 with formed sidewalls 120 shown configured of members in a triangular configuration which are formed by a bending of the distal end portions 122 of the members forming the outer spine 126 and inner spine 127. As in all modes of the device 10, the contact surfaces of the member-formed sidewalls 120 remain or return substantially parallel to each whether in contact with each other, or with the restrained media such as money. This return to a substantially parallel positioning yields maximum contact of the contact surfaces and the restrained media, during all positions of the contact surfaces when translating to a maximum separation.

FIG. 29 is a perspective view of the device 10 of FIG. 27, having sidewalls 121 and 123 formed of plastic, metal, or hybrid material. As shown the sidewalls 121 and 123 are in a contact and at their closest positioning. The member-formed sidewalls 120 are situated in channels 129 and distal segments 131 contact the sidewalls 121 and 123 to impart a torsional force around the axis of perpendicular portions of the distal end portions 122. This force acts to maintain the continuous parallel positioning of the two contact surfaces 132 of the sidewalls at all separation distances, and to thereby enhance the biased sandwiched engagement. This triangular format for sidewalls where formed or made from metal or other materials, yields a positioning of the points of the triangle to form a gap 140 providing the user a target for insertion which is particularly preferred.

FIG. 30 is a perspective view of the device of FIG. 29, showing the continuous parallel positioning of the contact surfaces 132 of the opposing sidewalls during translation away from each other to the shown expanded position. This substantially parallel positioning is maintained in all modes of the device 10 herein in the unique and novel mode of operation provided by the cross over 133 of the wire like members situated perpendicular to the contact surfaces 132 of all modes of the device 10 herein.

FIGS. 31 and 32 show views of the cross over 133 positioning of the wire-like members of the device 10 herein, and communicating with the formed sidewalls 121 and 123. The plane of the wire like members forming the cross over 133 is in all modes of the device herein, substantially normal to the plane of the opposing contact surfaces 132 formed on the formed sidewalls 120 or engaged sidewalls 121 and 123. This parallel positioning of the contact surfaces 132, as noted, is continuous in all sequentially increasing distanced positions, from a contact position such as FIG. 29, and translating to the separated positioning of FIGS. 31-33 where the contact surfaces 132 are spaced a distance apart determined by the thickness of the constrained item or material.

Finally, in FIG. 33 there is shown an end view with the contact surfaces 132 of the sidewalls 121 and 123, opposing each other in a parallel positioning continuously during translation from the contact positioning of FIG. 29 to the separated positioning of FIG. 32. Also shown is a guide 141 or member connection at the cross over 133 point for the members forming the cross over 133.

This invention has other applications, potentially, and one skilled in the art could discover these. The explication of the features of this invention does not limit the claims of this application; other applications developed by those skilled in the art will be included in this invention.

Thus, upon reading this disclosure, those skilled in the art may recognize various other improvements in clamping device which are considerably or slightly different than those disclosed, however are considered within the scope and intent of the invention herein, and are anticipated within the scope of this patent.

While all of the fundamental characteristics and features of the invention have been shown and described herein, with reference to particular embodiments thereof, a latitude of modification, various changes and substitutions are intended in the foregoing disclosure and it will be apparent that in some instances, some features of the invention may be employed without a corresponding use of other features without departing from the scope of the invention as set forth. It should also be understood that various substitutions, modifications, and variations may be made by those skilled in the art without departing from the spirit or scope of the invention. Consequently, all such modifications and variations and substitutions are included within the scope of the invention as defined by the following claims.

What is claimed is:

1. A clip comprising:
a member, said member having a first end portion formed to define a first perimeter edge of a first sidewall;
said first sidewall having first and second ends on opposite ends of a first linear section of said perimeter edge;
said member having a second end portion opposite said first end portion, said second end portion formed to define a second perimeter edge of a second sidewall;
said perimeter edge of said first sidewall having a first linear segment having first and second ends on opposite ends;
said perimeter edge of said second sidewall having a first linear section having first and second ends at opposite ends of said first linear section;
said first linear segment and said first linear section both running in a first direction;
a first diagonal portion of said member communicating between said first end of said linear segment and said second end of said linear section;
a second diagonal portion of said member communicating between said second end of said linear segment and said first end of said linear section;
said first diagonal portion of said member crossing over said second diagonal portion of said member at a crossover point;
said clip having a collapsed position wherein a first contact surface of said first sidewall is positioned adjacent to or in a contact with, a second contact surface of said second sidewall; and
said clip having an engaged position with said first contact surface translated a distance from said second contact surface and with said medium positioned in a sandwiched engagement in opposing respective contacts with said first contact surface and said second contact surface.

2. The clip of claim 1 additionally comprising:
said first contact surface occupying a first surface area within said first perimeter edge;
said second contact surface occupying a second surface area within said second perimeter edge;
translation of said first contact surface said distance from said second contact surface imparting a deformation to said first diagonal portion and second diagonal portion;
said deformation communicating a bias of said first contact surface toward said second contact surface;
said first contact surface and said second contact surface both remaining substantially parallel to a first plane in a parallel positioning, with said clip positioned in said engaged position;
said parallel positioning locating substantially all of said first surface area and said second surface area for a said opposing respective contact and biased engagement upon opposing surfaces of said medium therebetween, thereby providing means for maximizing a respective said contact surface area of both said first surface area and said second surface area, with opposing surfaces of said medium.

3. The clip of claim 1 additionally comprising:
said clip formed in a unitary structure by a serpentine configuration of said member.

4. The clip of claim 2 additionally comprising:
said clip formed in a unitary structure by a serpentine configuration of said member.

5. The clip of claim 2 additionally comprising:
said first diagonal portion of said member and said second diagonal portion of said member both running in or adjacent to a second plane, said second plane positioned substantially normal to said first plane, when said clip in said engaged position, whereby a volume of space occupied by said clip and said medium with said clip in said engaged position, is minimized and thereby optimized for occupying a minimized area within a finite space of a pocket or purse.

6. The clip of claim 4 additionally comprising:
said first diagonal portion of said member and said second diagonal portion of said member both running in or adjacent to a second plane, said second plane positioned substantially normal to said first plane, when said clip in said engaged position, whereby a volume of space occupied by said clip and said medium with said clip in said engaged position, is minimized and thereby optimized for occupying a minimized area within a finite space of a pocket or purse.

7. The clip of claim 2 additionally comprising:
said first perimeter area defining a first triangular shape having a first point of said first triangular shape opposite said first linear segment;
said second perimeter area defining a second triangular shape having a second point of said second triangular shape, opposite said first linear section;
a gap between said first point and said second point;
said gap defining a target for a user for an insertion of said media in between said first sidewall and said second sidewall and a concurrent translation of said clip to a said engaged position.

8. The clip of claim 4 additionally comprising:
said first perimeter area defining a first triangular shape having a first point of said first triangular shape opposite said first linear segment;
said second perimeter area defining a second triangular shape having a second point of said second triangular shape, opposite said first linear section;
a gap between said first point and said second point;
said gap defining a target for a user for an insertion of said media in between said first sidewall and said second sidewall and a concurrent translation of said clip to a said engaged position.

9. The clip of claim 2 additionally comprising:
a first planar sidewall having a first surface opposite a second surface;
a second planar sidewall having a first surface opposite a second surface;
said first planar sidewall engaged to said clip by a first receiving area formed on said first surface of said first sidewall, configured in a shape complimentary to said first perimeter edge;
said second planar sidewall engaged to said clip by a second receiving area formed on said first surface of said second sidewall, configured in a shape complimentary to said second perimeter edge;
said second surface of said first planar sidewall defining said first contact surface; and
said second surface of said second planar sidewall defining said second contact surface.

10. The clip of claim 4 additionally comprising:
a first planar sidewall having a first surface opposite a second surface;
a second planar sidewall having a first surface opposite a second surface;
said first planar sidewall engaged to said clip by a first receiving area formed on said first surface of said first sidewall, configured in a shape complimentary to said first perimeter edge;
said second planar sidewall engaged to said clip by a second receiving area formed on said first surface of said second sidewall, configured in a shape complimentary to said second perimeter edge;
said second surface of said first planar sidewall defining said first contact surface; and
said second surface of said second planar sidewall defining said second contact surface.

11. The clip of claim 5 additionally comprising:
a first planar sidewall having a first surface opposite a second surface;
a second planar sidewall having a first surface opposite a second surface;
said first planar sidewall engaged to said clip by a first receiving area formed on said first surface of said first sidewall, configured in a shape complimentary to said first perimeter edge;
said second planar sidewall engaged to said clip by a second receiving area formed on said first surface of said second sidewall, configured in a shape complimentary to said second perimeter edge;
said second surface of said first planar sidewall defining said first contact surface; and
said second surface of said second planar sidewall defining said second contact surface.

12. The clip of claim 6 additionally comprising:
a first planar sidewall having a first surface opposite a second surface;
a second planar sidewall having a first surface opposite a second surface;
said first planar sidewall engaged to said clip by a first receiving area formed on said first surface of said first sidewall, configured in a shape complimentary to said first perimeter edge;
said second planar sidewall engaged to said clip by a second receiving area formed on said first surface of said second sidewall, configured in a shape complimentary to said second perimeter edge;
said second surface of said first planar sidewall defining said first contact surface; and
said second surface of said second planar sidewall defining said second contact surface.
